(19) United States
(12) Patent Application Publication
(10) Pub. No.: US 2008/0310476 A1
(43) Pub. Date: Dec. 18, 2008

(54) Thermographic Method and Device for Determining the Damaged State of a Part

(75) Inventors: Thomas Ummenhofer, Braunschweig (DE); Justus Medgenberg, Steinweiler (DE)

Correspondence Address: SALTER & MICHAELSON;THE HERITAGE BUILDING, 321 SOUTH MAIN STREET, PROVIDENCE, RI, 029037128, US

(73) Assignee: TECHNISCHE UNIVERSITA CAROLO-WILHELMINA ZU BRAUNSCHWEIG, BRAUNSCHWEIG (DE)

(21) Appl. No.: 11/795,068

(22) PCT Filed: Jan. 12, 2006
(86) PCT No.: PCT/EP06/00244

§ 371 Date: Apr. 9, 2008

(30) Foreign Application Priority Data
Jan. 12, 2005 (EP) PCTEP/2005/00208

(51) Int. Cl. G01N 25/72

(52) U.S. Cl. 374/4

(57) ABSTRACT

Disclosed is a method for determining the degree to which parts, especially parts that are exposed to loads (11) which change over time, are damaged. According to the invention, the part (10) is actively excited (20). A sector of the surface of the excited part (10) is recorded by means of a thermographic apparatus (30) which records also small cracks, microcracks (15), and microplastic zones having a length or size of less than 2 mm on the surface of the part (10). The thermographic apparatus (30) feeds the recorded images with the small cracks, microcracks (15), and microplastic zones to an evaluation unit (40). The evaluation unit (40) systematically evaluates the represented distribution of the small cracks, microcracks (15), and microplastic zones according to a predefined process. The degree to which the part (10) has been damaged is determined from the evaluated data of the distribution of the small cracks, microcracks (15), and microplastic zones.

The invention relates to a method for determining the damaged state of a part. It also relates to a device for carrying out the method.

The state of parts is interesting in many respects. In the case of new parts, DE 100 53 112 A1, for example, proposes a method for quality assurance to determine material defects or detachments of superficially applied coatings (delaminations) in metallic or other semi-finished products or end products, which may have occurred during the production process. For this purpose, the part to be checked is acted upon by microwave signals and then the part is investigated with a thermographic analysis for the presence of material defects, for example, or individual large cracks.

DE 100 59 854 A1 also proposes a method, with which it can be determined whether a part has any damage. Ultrasound is introduced here into the part and the effect is used that a damaged point converts this sound into heat. Thus if a crack or a hole is present, this lights up selectively in a thermographic image.

Further possibilities for determining a defect in a part using thermography are proposed in DE 197 03 484 A1 by means of thermal excitation in the form of thermal elements and, in DE 101 53 592 A2, with the aid of a laser beam.

However, it is less relevant in many cases to recognise a material defect or other more or less great damage to a part and to separate out this part, for example, during quality assurance. Instead, it is a question, for example, of the material fatigue of parts, which are subjected to time-variable loads, for example. Until now, this has been carried out with methods involving destruction.

Thus, for example, the expected service life of parts is determined, for example, by means of dynamic fatigue tests in correspondingly equipped test machines if the expected load history is known or, to assess already present, older parts, comparative samples of critical detail points are investigated in test machines of the type which can be run from the new state to complete failure.

Retrospective determination of damage that has already occurred due to material fatigue on real parts without the presence of a technical incipient crack is only possible in special cases and has generally been carried out up until now by calculation. Metrological detection of this true degree of damage has not been possible until now. Research activities for determining the damage to parts of this type up until now have been directed at exploiting the changes of micromagnetic properties of the parts, investigating sound emissions or the changes in the global electric resistance of the entire part, checking global temperature changes in the fatigue tests or else using the changes in the energy dissipation on reaching specific threshold values of the damage.

An investigation published after the priority application by O. Plekhov, T. Palin-Luc, N. Saintier, S. Uvarov and O. Naimark “Fatigue crack initiation and growth in a 35CrMo4 steel investigated by infrared thermography”, in: Fatigue Fract Engng Mater Struct 28, 169-178 deals with thermographic recordings of fatigue crack regions. The investigations confirm that in the case of relatively large cracks from an order of magnitude of 2 mm and more, effects can be seen and encourage the provision of long-term investigations. The research group around O. Plekhov calculates a total value within an image from data of various pixels.

Specific details and suggestions are lacking despite these interesting proposals, which still do not allow any more precise predictions.

All the methods used until now for determining the degree of damage to existing parts are unsatisfactory as they can generally only be inadequately correlated with the actual damage processes taking place in the material of the part, or else accept a destruction of the part.

The object of the invention consists in proposing a method for determining the degree of damage to a part, which can be carried out without destruction and allows a more realistic determination of the degree of damage to the part. Moreover, a device which is suitable for this is to be proposed.

This object is achieved by a method for determining the degree of damage to a part, in which an active excitation of the part is carried out, a section of the surface of the excited part is recorded by means of a thermographic apparatus, which also records small cracks, microcracks and microplastic zones having a crack length or dimension of less than 2 mm present on the surface of the part, in which the thermographic apparatus supplies the recorded images with the small cracks, microcracks and microplastic zones to an evaluation unit, the evaluation unit systematically evaluates the imaged distribution of the small cracks, microcracks and microplastic zones according to a predefined method and in which the degree of damage to the part is determined from the evaluated data of the distribution of the small cracks, microcracks and microplastic zones.

The object is also achieved by a device for carrying out the method, with an excitation source for excitation of the part, with a thermographic apparatus for recording a section of the surface of the excited part with the small cracks, microcracks and microplastic zones having a crack length or dimension of less than 2 mm, present on the surface of the part, and with an evaluation unit for evaluating the images recorded by the thermographic apparatus and for determining the degree of damage to the part from the evaluated data of the distribution of the small cracks, microcracks and microplastic zones.

A method of this type or a device of this type operates without destruction, as the active excitation of the part requires no type of outer machining of the part, but can be carried out, for example, by one of the methods known from the prior art such as an excitation by microwaves, by thermal elements, by lasers, by ultrasound, by mechanical or by inductive excitations.

For the first time, thermography is used here, for example, not to determine a specific crack or a material defect or other defect. Instead, a thermal image is generated by the active excitation of the part and also takes into account small cracks, microcracks and microplastic zones, and wherein the distribution or population of small cracks, microcracks and microplastic zones is then evaluated in order to reach conclusions about the degree of damage that has actually occurred from the distribution pattern being produced.

The service life of the loaded part can be predicted substantially more precisely by this, and, in fact, all this without relevant impairment or noteworthy damage to the part having to be effected. At most, very thick corrosion protection layers should be removed before the thermal image recording.

This means, for example, that a steel bridge that has already been in operation for decades can be investigated on the spot by the method according to the invention without samples having to be cut out, drillings introduced or other destructions having to be carried out. The quite specific degree of damage from the decade-long operation of this steel bridge can be determined according to the invention and the expected still available service life or durability period of the steel bridge can also be predicted thereby.

This is not possible with the methods mentioned at the outset. These do not take into account small cracks, microcracks and microplastic zones, do not evaluate them and are ultimately not interested in them either, as this is also of course not required in the course of the quality assurance.

The existence of small cracks, microcracks and microplastic zones after corresponding loads is known per se; observation thereof on metal surfaces took place until now by light-microscopy in which the surfaces of the parts were polished before application of the load. X-ray and electron-microscope recording techniques were also used.

However, it is not possible to determine the degree of damage of loaded parts by these methods, as a subsequent polishing always required in this method always leads to the destruction of the small crack and microcrack population which is precisely to be investigated. X-ray recordings could in certain circumstances manage without a polishing, but a high outlay for apparatus is then required for recordings of this type such that measurements on site are in turn ruled out in practice. These methods therefore do not lead to success either.

Only the thought of using small cracks, microcracks and microplastic zones and their distribution and the parameters derived therefrom for characterising the degree of damage and making the small cracks, microcracks and microplastic zones visible and evaluable by means of thermographic methods, leads to a useful method for determining the degree of damage to parts.

In the scope of the present application, in agreement with substantial parts of the professional circles, small cracks are taken to mean cracks of the type with an average length of 100 μm to 2 mm. Microcracks are cracks with a length in the order of magnitude of the grain size or a plurality of grain sizes; that means that they have a length of about 10 μm to about 100 μm. Microplastic zones are regions, from which with continuous loading, microcracks and small cracks are produced or can grow therefrom or which form at the end of a growing crack or accompany it. They also have dimensions in the order of magnitude of one or more grain sizes.

As tests have shown, microcracks and microplastic zones can already be made visible by the thermographic method at a length of several 10s of μm, in other words with a length of clearly less than 2000 μm (equals 2 mm).

To summarise, small cracks, microcracks and microplastic zones are occasionally also called micromechanical damage or microdamage, but these terms are also overlaid with other meanings.

It is particularly preferred if the active excitation of the part takes place with varying excitation characteristics, the section of the surface of the excited part is recorded with the use of respective different excitation characteristics with the thermographic apparatus, and the evaluation unit systematically evaluates the plurality of images supplied to it.

In this case, it is primarily effective if the varying excitation characteristics include the amplitude and/or the frequency and/or the mean value of an excitation.

In each case, it is preferred if the active excitation of the part takes place with one or more continuously changing excitation characteristics or with one or more excitation characteristics changing step-wise.

This may take place, for example, in that the active excitation of the part takes place with excitation characteristics, which change with incremental steps.

An already damaged part or else a new part may, for example, be subjected to a time-dependent varying excitation with an amplitude which is increased step-wise in incremental steps. This may be based on an incremental step test. Conclusions about the remaining service life to be expected can be made by means of evaluation of the microplastic deformation. In this case, all types of threshold values, ratios, course values, etc., can be used.

It is of particular interest, that, with prior damage, non-linear dependencies of the data on the excitation characteristics occur, which allow a very clear differentiation of elastic, in other words reversible behaviour compared to plastic behaviour which is an indication of critical fatigue regions.

In the case of structurally and, with respect to outer appearance, the same notch details, local non-homogeneities can be detected, which previously could never yet be taken into account when the service life of a part was concerned. These may be unfavourable grain arrangements, inclusions, crystalline structures, internal stresses and geometric deviations, the effects of which on the course of damage now become metrologically determinable and predictable.

The taking into account of the dissipation of heat in the notch root and directly detecting the plastic signal components seriously improve the prediction possibilities.

The use of thermography and the thermographic detection of small cracks, microcracks and microplastic zones for the systematic determination of the small crack and microcrack population and the further use of data with regard to a damage analysis are provided by the invention. The inventive method can also be used for retrospective damage analysis on parts that are otherwise only accessible with difficulty, on site, even on critical detail points. Naturally, the method can also be used on samples of critical detail points in the laboratory, if this is desired.

It is particularly advantageous that the method according to the invention is possible for retrospective determination of the degree of damage of a part without all the prior knowledge of the load history of this part.

Further advantages are the relatively low outlay required for apparatus. The method is easy to handle, it can deal with all requirements with respect to mobility and can therefore also be used in a technologically problematical environment. It is also universally usable and is practically not subject to any restrictions to special engineering application areas.

Reference should also be made to the fact, and it should also be emphasised that the load history of the parts to be investigated can be very different. Projections or other considerations of the past are not required to carry out the method. Loads which vary greatly with regard to time and which have led to material fatigue of the part, and which are always problematical with conventional considerations, are not a problem here. A part, which has been heavily loaded for years, then left unloaded and finally further loaded again in a different direction of loading can also be observed in the state in which it is at the time of investigation as the investigation records the small cracks, microcracks and microplastic zones specifically present at this moment and determines the degree of damage therefrom, regardless of how this has come about in the past.

An important basis for monitoring, maintenance and further use of all fatigue-endangered structures is therefore provided.

The method can be used, in particular, in parts made of metal, in which a material fatigue and also a time-variable load is particularly relevant and is also of great importance because of the estimated service lives. However the method can also be usefully used for other materials, in which material fatigue is relevant.

It is particularly preferred if the thermographic apparatus uses a thermal image camera and a microscope lens. Particularly high geometric resolution can be produced, which is of corresponding use for the evaluation of small cracks, microcracks and microplastic zones, precisely by a microscope lens.

It would also be particularly preferred if the active excitation of the part is formed completely or partly by the operating load of the part on site. Moreover, it is advantageous if the active excitation of the part takes place by means of shakers and/or test apparatuses and/or ultra sound converters and/or mechanical operating loads (11) and/or thermal excitation sources, inductive excitation sources and/or electromagnetic excitation sources and/or eddy current excitation sources.

By the inclusion of the stressing of a part, that is “natural” to a certain extent, for example of a railway bridge, in the excitation, very relevant measured values can be obtained, in particular, of course, if the excitation characteristics of these “natural” loads are also measured and determined or known at the same time.

It is also advantageous if recordings of the section of the surface of the excited part are made one after the other with various degrees of resolution and evaluated in the evaluation unit.

In this manner, a type of zoom effect can be exploited. In a dynamically stressed part that is configured in a complex manner, the critical notch regions of the part may firstly be roughly observed and the regions recognised as relevant then observed selectively and locally. This process can even be automated.

It becomes possible, in this manner, to be able to distinguish notch details which primarily initiate failure and which can trigger the failure of a part, from notch details that secondarily initiate failure.

The presence of local plastic deformations in the notch root and the evaluation thereof with regard to intensity, expansion etc. and the already mentioned thermographic distinction between local plastic and elastic behaviour of the material by means of a corresponding evaluation of the data allow possibilities that were unsuspected until now for measurements at the microstructural level and corresponding prognoses, in contrast to conventional globally integrating procedures.

To determine the degree of damage of a part, in contrast to known procedures, no macroscopic incipient crack in the range of more than 100 μm needs to be present, as even plastifications close to the surface can be recognised without any crack.

The complete course of damage can also be observed in terms of time. It is to be noted that the timescale here is completely different than that during the generation and observation of the excitations.

The invention will be described in more detail below with the aid of an embodiment, in which

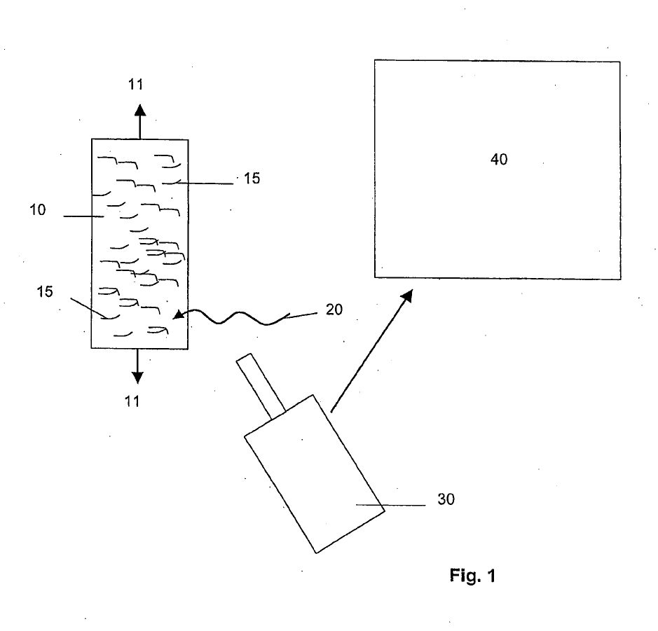

FIG. 1 shows a schematic view of a structure, on which the method according to the invention can be carried out.

FIG. 1 shows a part 10, for example a metallic part, which is reproduced purely schematically here as an elongated rectangle, but it may also have a completely different appearance. This part 10 is subjected to a time-variable load 11. This is shown schematically here by two arrows which indicate tensile forces on the part 10 in different directions.

As the part 10 in the schematic view has already been subjected to the time-variable loads 11 over a relatively long time period, a large number of small cracks, microcracks 15 and microplastic regions have formed. Depending on the type of loading and duration of loading, small cracks, microcracks and microplastic zones may only occur very locally and in specific notch details. The small cracks have a length of about 100 μm to 200 μm and the microcracks have a length of 10 μm to 100 μm on average and the microplastic regions have similar longitudinal dimensions. In general, the microcracks have lengths of several tens of pm and the small cracks up to several hundred μm.

The method now operates so an active excitation 20 is supplied to the part 10. This is illustrated in form of a wave here. Depending on the special embodiment, this may involve microwaves, laser beams, ultrasound, mechanical and inductive excitations or else other forms. In particular, excitation in the so-called lock-in method is intended.

A thermographically detectable structure, both as an instantaneous recording and also over the course of time, is produced by the excitation 20 of the part 10. This thermal image can be recorded with a thermographic apparatus 30, which is directed onto a section of the surface of the excited part 10. The thermographic apparatus 30 has a thermal image camera and a lens, in particular a microscope lens.

The thermographic apparatus 30, in particular, has a thermal resolution of 0.1 Kelvin or better and a pixel resolution of 50 μm or less or in the order of magnitude of the defect size and passes the recorded thermal image or the images with the small cracks, microcracks and microplastic zones to an evaluation unit 40. This evaluation unit 40, in particular, has a computer and other suitable hardware (printer, screens, memory, etc.). The evaluation unit 40 also knows parameters and methods for data evaluation of the images, which are supplied by the thermographic apparatus 30, and, from the position, the number, the length, the direction, the shape etc. of the various small cracks, microcracks and microplastic regions, can provide information about the degree of damage to the observed part. The damaged state of the material of the part is thereby determined.

The small cracks, microcracks 15 and microplastic zones on the surface of the part 10 can be recognised independently of the quality of the surface of the part 10 even under possibly present coatings, recorded by the thermographic apparatus 30 and therefore evaluated in the evaluation unit 40. A retrospective determination of the degree of damage to the part 10 is therefore also possible onsite. The method is therefore not linked to use in a laboratory on specially prepared sample bodies.

It is not shown that for the positioning, in particular of the thermographic apparatus 30, optionally a corresponding stand or other aid may be used. The transmission of the images or the information relating to these images from the thermographic apparatus 30 to the evaluation unit 40 may also take place in the most varied manner, also including remote transmission. The evaluation unit 40 therefore does not have to be in the direct vicinity of the part 10.

The most varied excitation sources are available as excitation sources for the excitation 20 to activate the part 10 and to make visible the small cracks, microcracks 15 and microplastic zones with the aid of thermography. These also include, inter alia, a thermal excitation by means of lamps, heating sources, lasers and the like, excitation by inductively produced heat, excitation by current flow, excitation by ultrasound, which can be generated by converters, ultrasound lasers or other devices, mechanical excitation of low frequency, excitation by electromagnetic radiation even outside the above-mentioned examples.

Depending on the type of excitation source, small cracks, microcracks and microplastic zones can then be excited by a local disturbance of the heat flow, the thermal heating behaviour, the thermal cooling behaviour, by a conversion of mechanical energy into thermal energy in the small crack and microcrack region or by using the thermoplastic or thermoelastic effect, in particular also taking into account the sign inversion to change the emission, transmission or reflection behaviour thereof in the infrared range and can be made visible with the aid of the thermographic apparatus with the thermal image camera in the form of digital images.

The excitation 20 may take place, in particular with varying excitation characteristics, for example with the amplitude increasing step-wise, with a different frequency or different mean value.

As experiments have already confirmed, the effects accompanying damage behave in a non-linear manner, so substantial distinctions become possible between plastic and elastic behaviour in locally narrowly restricted regions.

A large number of evaluation algorithms are available for the evaluation of the thermographic recordings, such as Fourier transformations, wavelet analyses, neural networks, also further conventional methods of digital image processing such as, for example, averaging, filtering etc. The degree of damage to the structure of the part 10 investigated can be determined by a correlation of parameters of the small crack, microcrack and microplastic zone population such as length, width, crack density, number etc. or else from combinations thereof or a comparison of the determined small cracks, microcracks and microplastic zones with previously determined comparison images.

It is also conceivable to scan a section of the part 10 or to carry out and evaluate a zoom-like observation of the part 10 from a macroscopic order of magnitude through to the microscopic observation of the small cracks, microcracks 15 and microplastic zones of the part 10.

For the first time, the invention allows a determination of the degree of damage during the service life and, in particular, also during operation of the part 10 to be evaluated. The invention allows a clear advance for service life prognostic methods on real parts.

Apart from use in construction, numerous further engineering application fields are conceivable, such as in vehicle construction, in aircraft, in power station construction, for wind power systems, in bridge construction and in diverse further steel constructions and other applications.

It is not only possible to estimate an expected further service life of the part 10 from the information about the degree of damage, but also optionally to make a timely decision about the introduction of possibly required reconstruction measures to influence the service life or to steer the loading for the future in certain directions or limits.

Tests have already shown that the fatigue processes in the material fatigue cause microstructural changes primarily on the surfaces of the part, or are initiated there. Superimposed stresses consisting of normal and bending elongations occur on the surface of the parts, which can also impact on notches caused by the production process. It can be concluded from this that especially the changes occurring on the surface of the part 10 allow clear characterisation of the state of material fatigue. Determining the degree of damage by a two-dimensional determination on the surface of the part is therefore significant and also adequate.

Non-superficially open cracks just below the surface, can also be recorded because of the heat dissipation effects and taken into account according to the invention.

### List of Reference Numerals

10 part

11 load, loading

15 microcracks

20 excitation

30 thermographic apparatus

40 evaluation unit

1. Method for determining the degree of damage of a part, wherein
an active excitation of the part is carried out,
a section of the surface of the excited part is recorded by means of a thermographic apparatus, which also records small cracks, microcracks and microplastic zones having a crack length or dimension of less than 2 mm present on the surface of the part,
the thermographic apparatus supplies the recorded images with the small cracks, microcracks and microplastic zones to an evaluation unit,
the evaluation unit systematically evaluates the imaged distribution of the small cracks, microcracks and microplastic zones according to a predefined method and carries out a determination of the degree of damage to the part from the evaluated data of the distribution of the small cracks, microcracks and microplastic zones.

2. Method according to claim 1, characterised in that the active excitation of the part takes place with varying excitation characteristics, in that the section of the surface of the excited part, during the application of respective different excitation characteristics, is recorded with the thermographic apparatus, and in that the evaluation unit systematically evaluates the images supplied to it in the case of different excitation characteristics.

3. Method according to claim 2, characterised in that the varying excitation characteristics include the amplitude and/or the frequency and/or the mean value of an excitation.

4. Method according to claim 2, characterised in that the active excitation of the part takes place with a continuously changing excitation characteristic or a plurality of continuously changing excitation characteristics or with an excitation characteristic changing step-wise or a plurality of excitation characteristics changing step-wise.

5. Method according to claim 4, characterised in that the active excitation of the part takes place with excitation characteristics, which change in incremental steps.

6. Method according claim 1, characterised in that the method is carried out during the loadings of the part on site.

7. Method according to claim 6, characterised in that the active excitation of the part is formed completely or partly by the operating loading of the part on site.

8. Method according to claim 1, characterised in that the active excitation of the part takes place by means of shakers and/or test apparatuses and/or ultrasound converters and/or mechanical operating loads and/or thermal excitation sources, inductive excitation sources and/or electromagnetic excitation sources and/or eddy current sources.

9. Method according to claim 1, characterised in that recordings of the section of the surface of the excited part are carried out one after the other with different degrees of resolution and evaluated in the evaluation unit.

10. Method according to claim 1, characterised in that the time course of the data during the excitation is evaluated in the evaluation unit for each pixel of the recording and the results of this evaluation are related to the degree of damage present and/or the expected damage course.

11. Method according to claim 1, characterised in that the thermographic apparatus carries out the recordings by means of a thermal image camera and a microscope lens.

12. Method according to claim 11, characterised in that a thermal image camera with a thermal resolution of 0.1 Kelvin or better is used.

13. Method according to claim 1, characterised in that the thermographic apparatus has a pixel resolution of 50 μm or less.

14. Method according to claim 1, characterised in that the method is carried out on parts subjected to time-variable loads.

15. Method according to claim 1, characterised in that the method is carried out on metallic and/or plastics material and/or fibre-reinforced plastics material parts.

16. Device for carrying out one of the aforementioned methods,
with an excitation source for excitation of the part,
with a thermographic apparatus for recording a section of the surface of the excited part with the small cracks, microcracks and microplastic zones having a crack length or dimension of less than 2 mm, present on the surface of the part, and
with an evaluation unit for evaluating the images recorded by the thermographic apparatus and for determining the degree of damage to the part from the evaluated data of the distribution of the small cracks, microcracks and microplastic zones.

17. Device according to claim 16, characterised in that the excitation source for the excitation of the part provides varying excitation characteristics.

18. Device according to claim 17, characterised in that the excitation source for the excitation of the part provides excitations with a different amplitude and/or frequency and/or mean value.

19. Device according to claim 17, characterised in that the excitation source for the excitation of the part can carry out the varying excitation in a time-controlled manner.

20. Device according to any one of claims 16, characterised in that the excitation source for the excitation of the part has shakers and/or test apparatuses and/or ultrasound converters and/or mechanical operating loads and/or thermal excitation sources, inductive excitation sources and/or electromagnetic excitation sources and/or eddy current excitation sources.

21. Device according to claim 16, characterised in that the thermographic apparatus is equipped to record images with a different scale.

22. Device according to claim 16, characterised in that the thermographic apparatus has a thermal image camera and a microscope lens.

23. Device according to claim 22, characterised in that the thermal image camera has a thermal resolution of 0.1 Kelvin or better.

24. Device according to claim 16, characterised in that the thermographic apparatus has a pixel resolution of 50 μm or less.
